(19) United States
(12) Patent Application Publication
(10) Pub. No.: US 2012/0027368 A1
(43) Pub. Date: Feb. 2, 2012

(54) HOLLOW CORE FIBER POWER COMBINER AND DIVIDER

(75) Inventors: Lalitkumar Bansal, Spartanburg, SC (US); Daiichiro Tanaka, Chiba-ken (JP); Chandraika (John) Sugrim, Spartanburg, SC (US)

(73) Assignee: AFL TELECOMMUNICATIONS LLC, Spartanburg, SC (US)

(21) Appl. No.: 12/809,419

(22) PCT Filed: Dec. 15, 2009
(86) PCT No.: PCT/US2009/068019

§ 371 Date: May 12, 2011

Related U.S. Application Data
(60) Provisional application No. 61/122,463, filed on Dec. 15, 2008.

(51) Int. Cl. G02B 6/04; C03B 37/01

(52) U.S. Cl. 385/115; 65/393

(57) ABSTRACT

A method for manufacturing a hollow core fiber power combiner or divider is provided. The method includes forming a hollow core fiber bundle by assembling a plurality of small core diameter hollow core fibers inside a large diameter inner capillary. The method further includes inserting a support structure inside each of the plurality of small core diameter hollow core fibers and collapsing the large diameter inner capillary on the plurality of small core diameter hollow core fibers having the supported structure inserted to form a fused small core fiber bundle. The method further includes combining the fused small core fiber bundle with a large core diameter hollow core fiber. The structure of the hollow core fiber power combiner and divider is also provided.

The present application claims priority from U.S. Provisional Patent Application No. 61/122,463, filed on Dec. 15, 2008, the content of which is incorporated herein by reference.

### BACKGROUND

Hollow core fibers have generated considerable interest in the fiber optics industry as well as in academics. This is because hollow core fibers show a relatively low loss in the ultraviolet/infrared (UV/IR) region of the electromagnetic spectrum in comparison to solid core pure silica fibers. Hollow core fibers have several other advantages such as high laser power thresholds, low insertion loss, no end face reflections and small beam divergence. Due to their low IR loss and high damage threshold (air core) they find applications in high power CO2 laser delivery for IR laser surgery and industrial CO2 laser welding. The current technology in hollow core fibers is largely limited to fiber fabrication, and its use in high power beam delivery and sensing. There are very limited passive devices made from hollow core fibers. The following few paragraphs describe some basic information about hollow core fibers.

Hollow core fibers acting as, for example, waveguides are fibers in which the core material 301 may be air (n=1) and the cladding material 302 is a material with lower refractive index than the core (air). An example of the cladding material is sapphire (n=0.67 at 10.6 μm). In the example, shown in FIG. 3a, light travels based on total internal reflection at the core-cladding interface. Another mode of light transmission in the hollow core fiber is through pure reflection as shown in FIG. 3b. A very highly reflective material 304 such as Silver is provided at the core-capillary interface (interface between core 301 and capillary 303) that reflects the light traveling in the hollow core fiber. The reflection may be further enhanced by adding a dielectric coating 305 over the silver layer, the principle of transmission in this case being that of constructive interference after multiple reflections, as shown in FIG. 3c.

FIG. 4 shows the effect of adding a dielectric layer 305 over the silver coating 304. The peaks in the spectrum are due to the interference phenomena. As can be seen from FIG. 4, the losses for the Ag-only film guide are 100 times higher than the Ag/AgI film guide, the exact reason for this decrease in loss after adding AgI layer is not clear. Omnidirectional waveguides, which have alternate high and low refractive index dielectrics as the cladding, may also be used as hollow core waveguides.

Structure of Hollow Core Fiber

Hollow-core waveguides may be grouped into three categories:

a) Attenuated Total Internal Reflection (ATIR) Type

ATIR type hollow waveguides are waveguides whose core 301 is air and cladding material 302 has a refractive index less than one. The waveguides may include a third final coating layer 501 of Acrylate or Polyimide. The coating layer 501 provides protection from environment and mechanical damage to the fiber. Hollow core sapphire fibers operating at 10.6 μm (n=0.67) are an example of this class of hollow guide. The structure of this type of waveguide is shown in FIG. 5. The advantage of this type of fiber is its high thermal capability as sapphire fibers are used in high temperature applications. The main disadvantage is the complex and time consuming process of fabrication requiring growth of crystalline sapphire. Sapphire forms the cladding material.

b) Leaky-Type Hollow Core Waveguides (HWG's)

Leaky-type hollow core waveguides are those in which the core is air and cladding material has refractive index greater than one (leaky guides). The waveguides may be coated with a layer of acrylate, polyimide, etc. Alternatively, light guiding in these waveguides may be attained by having metallic and dielectric films deposited on the inside of a metallic, plastic, or glass tubing that serves as the cladding. These highly reflective films are used to confine the light to the air core. Based on the type of reflective wall used on the inside of the cladding of this waveguide, there are several categories of Leaky-type HWGs. The most basic design uses a smooth metal surface as the inner wall of the waveguide. The wave guide as a whole is a metal pipe, and has a smooth inside surface that serves as a reflection surface for the radiation. FIG. 6a shows an example of this kind of waveguide, which is a hollow metal tube, with a metal layer as cladding 302. The main advantage of this type of waveguide is mechanical stability as they are not as brittle as their glass counterpart and do not require a coating, therefore long lengths of waveguides can be drawn or deposited in a continuous process. The main disadvantage is that they are not as flexible as their glass and plastic counterparts.

A smooth metal coating 602 can also be deposited on the inner surface of a glass or plastic tube forming the cladding 302, as shown in FIG. 6b. The main advantages of this waveguide is its simple design, and flexibility. These waveguides are however limited by the surface quality and by the metallic films included in the smooth metal coating 602.

To enhance the reflection of the inner surface, a dielectric layer 603 can be added over the metal layer, as shown in FIG. 6c. This type of structure is the most popular hollow core waveguide today, the main advantage of this type of structure is enhanced reflection from the metallic surface and the simplicity of the fabrication process. As it is made by a batch process it is limited by the short lengths of fiber that can be processed. It is found (discussed in detail in the following paragraph) that if multiple layers of dielectric are added by depositing alternating high/low refractive index dielectric layers over metal film, the absorption of such a multilayer structure decreases exponentially as the number of layer pairs increases. Such a structure with dielectric layers 604 and 605 with alternating high/low refractive indices is shown in FIG. 6d. However, the exact reason for this superior performance is not known. It is believed that the superior performance is due to constructive thin film interference. If the number of dielectric layers are infinite then the light can be maintained inside the core without the metal layer. Such a hollow waveguide with no metal layer but just alternate high/low dielectric layers is known as a hollow bragg fiber. A hollow bragg fiber is shown in FIG. 6e.

c) Photonic Crystal Hollow Core Fiber (PCF)

A Photonic crystal hollow core fiber 700, shown in FIG. 7 utilizes a two dimensional periodic dielectric structure to confine light to the air core. PCF's have a series of air channels stretching along the length of the waveguide that are arranged in a hexagonal lattice. Several air holes are removed from the center of the waveguide to create a defect in which light can propagate with low loss.

The conventional solid core fiber power combiner and divider technology utilizes a single large core fiber facing a fused fiber bundle of several smaller solid core fibers. In a power combiner technology, the output of many small fibers (small in diameter) is fed to a single large fiber and the combined energy of the signals being transmitted by the small fibers minus energy lost due to various factors such as transmission losses, appears at the output of the large core fiber. In a power divider technology, energy is input to a large core fiber, which then transmits the input energy to multiple smaller core fibers. The input energy such as energy due to an electromagnetic signal is split between the smaller core fibers and appears at the output of the respective smaller core fibers.

### SUMMARY

According to an exemplary embodiment, a hollow core fiber power combiner includes a plurality of small core diameter hollow core fibers forming a bundle and serving as an input to an energy source; and a large core diameter hollow core fiber serving as a output fiber and operatively coupled to the bundle formed by the plurality of small core diameter hollow core fibers, wherein the plurality of small core diameter hollow core fibers are held together in a bundle by a first capillary.

According to another exemplary embodiment, a hollow core fiber power divider includes a plurality of small core diameter hollow core fibers forming a bundle and serving as an input to an energy source. The hollow core fiber power divider also includes a large core diameter hollow core fiber serving as a output fiber and operatively coupled to the bundle formed by the plurality of small core diameter hollow core fibers, wherein the plurality of small core diameter hollow core fibers are held together in a bundle by a first capillary.

According to another exemplary embodiment, a method for manufacturing a hollow core fiber power combiner or divider is provided. The method includes forming a hollow core fiber bundle by assembling a plurality of small core diameter hollow core fibers inside a large diameter inner capillary. The method further includes inserting a support structure inside each of the plurality of small core diameter hollow core fibers and collapsing the large diameter inner capillary on the plurality of small core diameter hollow core fibers having the supported structure inserted to form a fused small core fiber bundle. The method further includes combining the fused small core fiber bundle with a large core diameter hollow core fiber.

### BRIEF DESCRIPTION OF THE DRAWINGS

Certain aspects of the present disclosure will become more apparent by describing in detail illustrative, non-limiting embodiments thereof with reference to the accompanying drawings, in which like reference numerals refer to like elements in the drawings.

FIGS. 1a to 1d illustrate a power combiner/divider device according to an exemplary embodiment.

FIGS. 2a and 2b describe a fabrication method of the device described in FIG. 1a according to another exemplary embodiment.

FIGS. 3a, 3b, and 3c illustrate the operation of a hollow core fiber.

FIG. 4 is a graph showing the effect of adding a dielectric layer inside a hollow core fiber.

FIG. 5 illustrates an ATIR type hollow core fiber.

FIGS. 6a thru 6e illustrate different types of Leaky hollow core fiber waveguide structures.

FIG. 7 illustrates a conventional photonic crystal fiber.

### DETAILED DESCRIPTION

Exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts may be omitted for clarity, and like reference numerals refer to like elements throughout.

A hollow core power combiner/divider may provide an advantage of combining or dividing power in the far IR region of the electromagnetic spectrum. Currently, this advantage is not available using solid core IR transmitting fluoride based fibers. However, such an application of hollow core fibers to a power combiner/divider structure is not obvious and no prior art is known to the inventors of this disclosure. This is because application of a fabrication technique similar to that of the solid core power combiner/divider structure, to hollow core fibers will lead to a collapse of the small core fibers when they are fused.

Exemplary embodiments of the present disclosure provide a technique to create a fused hollow core fiber bundle that avoids the hollow core fiber collapse that can occur in the conventional fabrication technology. The fused hollow core fiber bundle may then be attached to another large core fiber to develop a hollow core fiber power combiner/divider. A non-exhaustive list of potential applications for the exemplary hollow core fiber combiner/divider is laser welding, laser surgery and photodynamic therapy. Various other applications of the exemplary embodiments disclosed herein will be apparent to one of ordinary skill in the art.

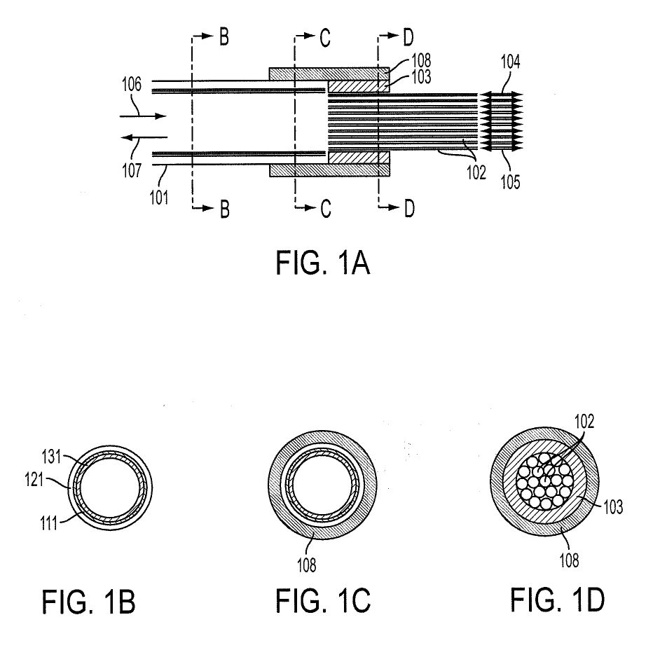

The Hollow core fiber power Combiner/Divider structure according to an exemplary embodiment is shown in FIGS. 1a to 1d. It consists of a large core diameter hollow core fiber 101 facing several small core diameter hollow core fibers 102. An exemplary inner diameter range for the large core diameter hollow core fiber 101 is 2000 μm to 1000 μm, an exemplary inner diameter range for the smaller core diameter hollow core fibers 102 is 1000 μm to 200 μm inner diameter. Several small core diameter hollow core fibers (also referred to as small core fiber in this specification) 102 are fused together using an outside capillary tube 103. The outside capillary tube 103 may be a glass capillary tube, or may be made of ceramic or any other material capable of sustaining a high temperature. This fused section of the small core diameters hollow core fibers is then aligned in front of a large diameter hollow core fiber. In the power combiner mode each individual small core diameter hollow core fiber may be excited with laser radiation 104 or some other electromagnetic signal (indicated by left facing arrow) and combined at the glass capillary junction and the combined power can be fed to the large core diameter hollow core fiber (also referred to as large core fiber in this specification) 101. The combined power (light output 107) is output at the end of the large core fiber 101 that is opposite to the junction with the small core fibers. In the power divider mode the large core fiber can be excited again with laser radiation 106 or other electromagnetic signal, and the final output 105 is seen at one end of the small core fibers. The function of the outer capillary tube 108 is to align the large diameter fiber with the multiple small diameter fibers. Exemplarily, the outer capillary tube 108 may be present throughout the use of the power combiner/divider structure.

FIG. 1b shows a cross-section along B-B corresponding to the large core fiber. The large core fiber includes a hollow tube on the outside. The hollow tube may be made of glass, metal such as Nickel, Stainless steel or plastic such as Polyethylene, Teflon, capillary. Inside the hollow tube, an inner metallic reflective layer 111 is provided. The reflective layer 111 is primarily made of silver, it may be also made with gold or aluminum. The refractive index of the reflective layer depends on the wavelength or the process of deposition and film thickness. The metallic reflective layer 111 is further coated with a dielectric layer referred to as a transparent layer 131 for enhanced reflection due to interference. Furthermore, multiple dielectric layers of alternating high and low refractive index may be provided as the transparent layer 131. Example materials for the transparent material may be AgI, AgBr, ZnS, ZnSe, PbF2, etc.

The small diameter hollow core fibers 102 have a structure similar to the large core fiber 101, that is, they also have hollow tube, a reflective layer, and a transparent layer.

FIG. 1c shows a cross-section along C-C.

FIG. 1d shows a cross-section along D-D.

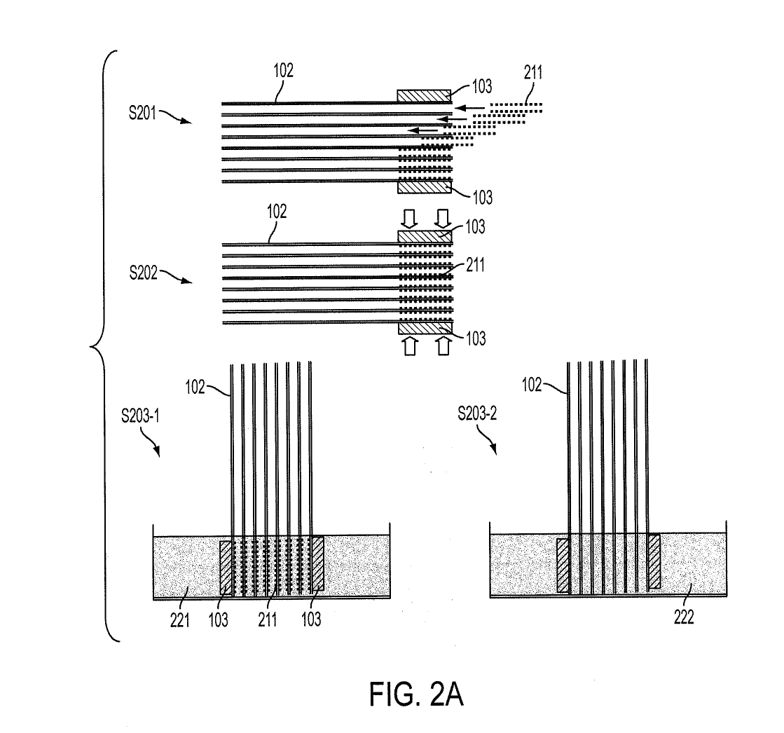

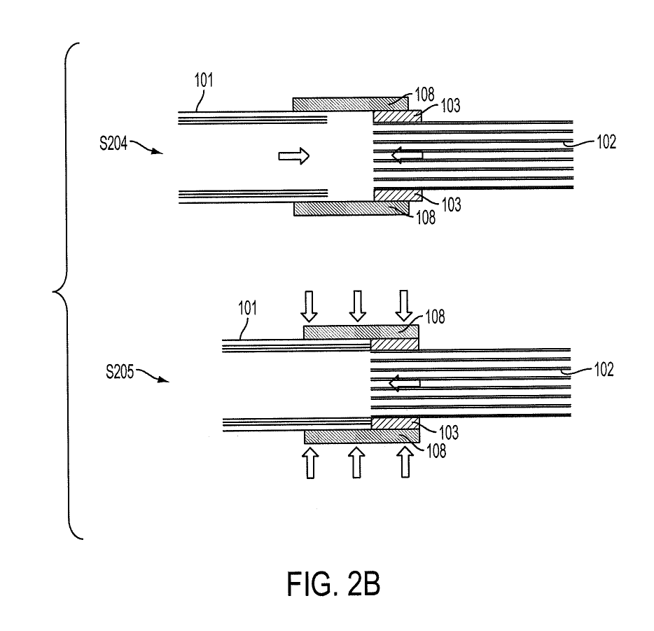

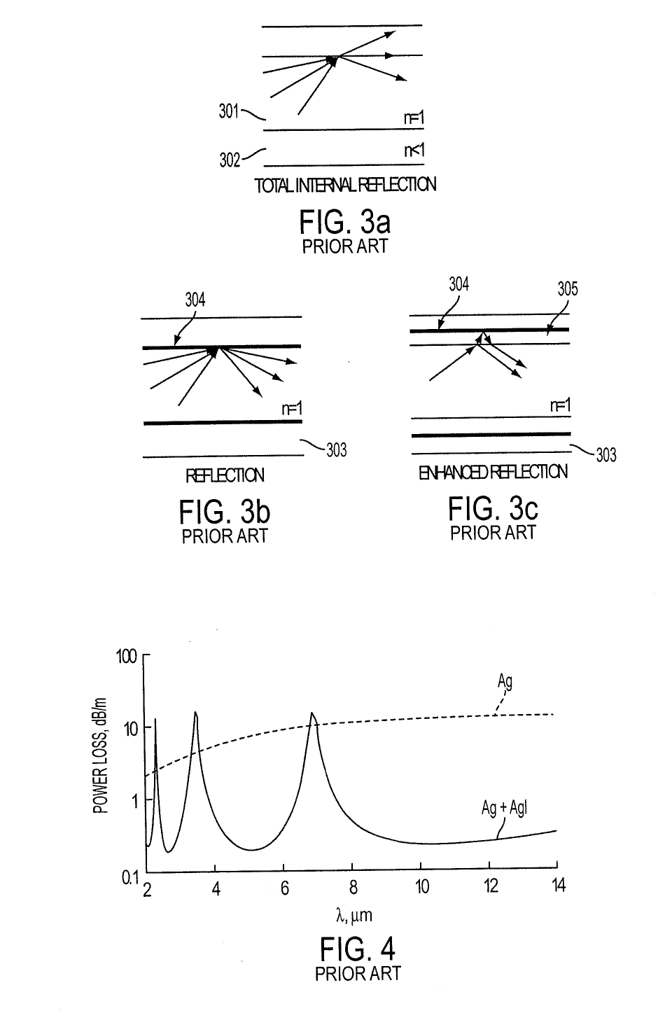

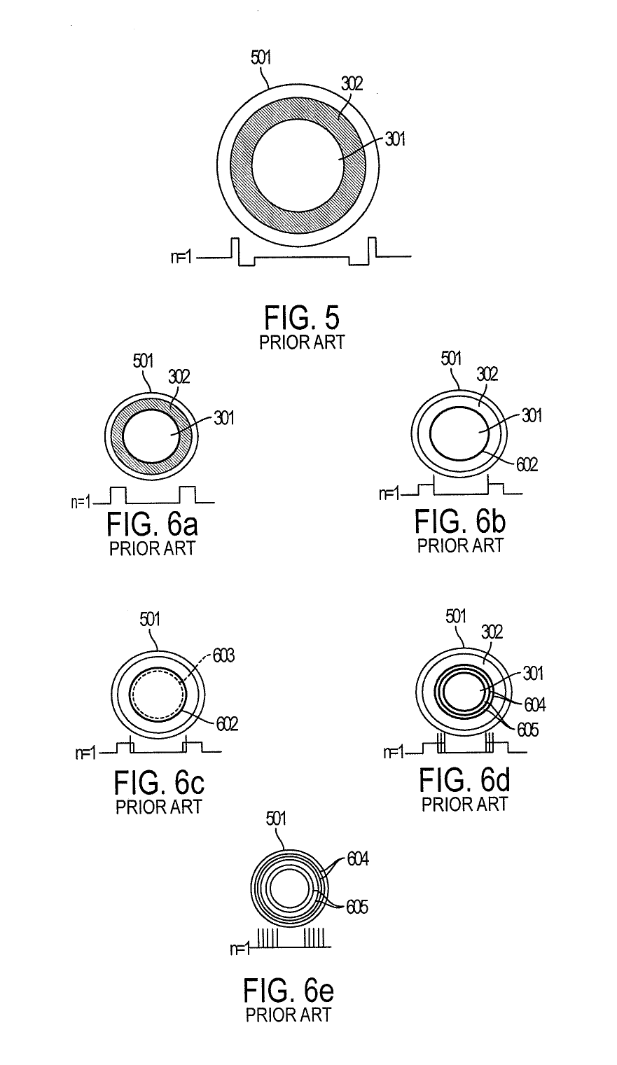

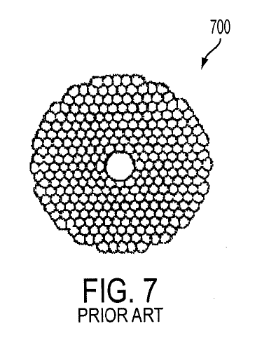

Next, an exemplary fabrication method for the above power combiner/divider device will be described in relation to FIGS. 2a and 2b.

Initially, a hollow core fiber bundle is formed by inserting the smaller diameter hollow core fibers 102 in a large diameter capillary (inner capillary) 103 and then stuffing each small core fiber with high melting point refractory metal rings 211 (Tungsten) or ceramic ring as shown in S201 FIG. 2a. The stuffing acts as a support material preventing the collapse of the small hollow core fibers. Length of the inserted metal ring may be equal to or greater than the inner capillary tube. The high temperature refractory metals used to stuff the small core diameter hollow core fibers may be Tungsten (melting point 3,422° C.), Molybdenum (melting point 2,623° C.), Niobium (melting point 2,468 C.), Tantalum (melting point 3017 C.) and Rhenium (melting point 3186 C.). The refractory metal rings may also be first inserted at room temperature in the individual fibers 102 and the individual fibers 102 may be bundled together later and inserted in the inner capillary 103.

Next, the inner capillary 103 is collapsed in 5202 on the stuffed hollow core bundle prepared in 5201 as shown in FIG. 2a to prepare a fused small core fiber bundle. The inner capillary may be collapsed using a heat source such as a CO2 laser, an electric heater, and Infra red furnace, a flame, etc. Exemplarily, the inner capillary 103 may be simply attached with the stuffed hollow core bundle prepared in S201, using an epoxy resin or any other resin curable using a high energy source. If a flame is used, the flame may be formed by a compound such as a hydrocarbon with chemical structure CxHyOz and Oxygen, where x, y, and x are integers. The inner capillary may be collapsed by softening it by heating it to a temperature just lower than the melting point of the material, e.g. in case of glass 2300° C. The equipment needed would be a heat source which can heat the capillary uniformly up-to its softening temperature e.g. CO₂ laser, electric heater or a hydrogen oxygen flame. Other equipment may be needed such as mechanical holders to hold the fiber bundle in place while the capillary is collapsed over the bundle.

The fiber bundle prepared in 5202 is immersed in an etching solution 221 to etch out the supporting metal rings inserted inside the hollow fibers (S203-1). Depending upon the type of metal ring used, an exemplary table shown below provides the wet etching solution for various metals.

TABLE 1
Wet etching solution for various refractory metals.

| Refractory Metal | Etching Solution |
|---|---|
| Tungsten | 4:1 HF:HNO₃, H₂O₂, 1:2 NH₄OH:H₂O₂ |
| Molybdenum | 1:1 HCl:H₂O₂ |
| Niobium | 1:1 HF:HNO₃ |
| Tantalum | 1:1 HF:HNO₃ |
| Rhenium | 3:1 HCl:HNO₃ |

S203-2 is implemented if the inner capillary collapse (S202) and/or the etching solution (S203-1) damages the inner coating layers of the small diameter hollow core fibers. In S203-2 the section of the fiber bundle exposed to the etching solution is recoated with a silver or other reflective coating material 222, to minimize losses due to coating loss.

In S204 the bundle prepared in the S203 or S203-1 is inserted in a glass capillary (outer capillary 108) from one side, from the other side a large hollow core fiber is inserted, as shown in FIG. 2b.

In S205, the outer capillary 108 is attached to the hollow core fiber bundle prepared in S204 and the large hollow core fiber 101 by using a UV or thermal cure epoxy or by collapsing the outer capillary tube onto the fiber bundle and the large hollow core fiber.

In the exemplary embodiments discussed above, the hollow core fibers may be any one of omnidirectional waveguide and a photonic crystal fiber.

The exemplary hollow core power combiner discussed above provides with a unique advantage of mixing wavelengths at the output. The exemplary fabrication technique discussed above may overcome potential hazards and safety issues associated with making a combiner/divider using solid core IR transmitting fluoride based fibers. The reason is that if a bundle is formed by collapsing fluoride based fibers there is degassing of gases containing fluorine which is very hazardous. Furthermore, IR transmitting fluoride based fibers have mechanical properties that depend on humidity, that is, they become very brittle in increased humidity making them further unsuitable for the combiner application.

The foregoing exemplary embodiments may have certain other advantages, including:

1) Wavelength mixing from various light sources, which could find applications in photo-dynamic therapy i.e. drugs activated by different wavelengths, or use the special therapeutic properties (like blood coagulation) of CO₂ laser wavelength while being mixed with other wavelengths.
2) Combining optical power from several small power sources for high power welding.
3) Dividing optical power from a single high power laser to create several smaller power stations useful in laser surgery applications.

The description of the exemplary embodiments has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1. A hollow core fiber power combiner comprising:
a plurality of small core diameter hollow core fibers forming a bundle and serving as an input to an energy source; and
a large core diameter hollow core fiber serving as a output fiber and operatively coupled to the bundle formed by the plurality of small core diameter hollow core fibers,
wherein the plurality of small core diameter hollow core fibers are held together in a bundle by a first capillary.

2. The hollow core fiber power combiner according to claim 1, wherein at least one of the plurality of small core diameter hollow core fibers has an inner metallic reflector layer coated with at least one dielectric layer.

3. The hollow core fiber power combiner according to claim 1, wherein at least one of the plurality of small core diameter hollow core fibers has an inner metallic reflector layer coated with a plurality of dielectric layers having different refractive indices.

4. The hollow core fiber power combiner according to claim 1, wherein at least one of the plurality of small core diameter hollow core fibers has an inner metallic reflector layer coated with a plurality of dielectric layers comprising dielectric layers of alternating high and low refractive index.

5. The hollow core fiber power combiner according to claim 1, wherein at least one of the plurality of small core diameter hollow core fibers is a photonic crystal fiber.

6. The hollow core fiber power combiner as claim 1, wherein the large core diameter hollow core fiber is an omniguide fiber.

7. A hollow core fiber power divider comprising:
a plurality of small core diameter hollow core fibers forming a bundle and serving as an input to an energy source; and
a large core diameter hollow core fiber serving as a output fiber and operatively coupled to the bundle formed by the plurality of small core diameter hollow core fibers,
wherein the plurality of small core diameter hollow core fibers are held together in a bundle by a first capillary.

8. The hollow core fiber power divider according to claim 7, wherein at least one of the plurality of small core diameter hollow core fibers has an inner metallic reflector layer coated with at least one dielectric layer.

9. The hollow core fiber power divider according to claim 7, wherein at least one of the plurality of small core diameter hollow core fibers has an inner metallic reflector layer coated with a plurality of dielectric layers having different refractive indices.

10. The hollow core fiber power divider according to claim 7, wherein at least one of the plurality of small core diameter hollow core fibers has an inner metallic reflector layer coated with a plurality of dielectric layers comprising dielectric layers of alternating high and low refractive index.

11. The hollow core fiber power divider according to claim 7, wherein at least one of the plurality of small core diameter hollow core fibers is a photonic crystal fiber.

12. The hollow core fiber power divider according to claim 7, wherein the large core diameter hollow core fiber is a photonic crystal fiber.

13. A method for manufacturing a hollow core fiber power combiner or divider, the method comprising:
forming a hollow core fiber bundle by assembling a plurality of small core diameter hollow core fibers inside a large diameter inner capillary;
inserting a support structure inside each of the plurality of small core diameter hollow core fibers;
collapsing the large diameter inner capillary on the plurality of small core diameter hollow core fibers having the supported structure inserted to form a fused small core fiber bundle; and
combining the fused small core fiber bundle with a large core diameter hollow core fiber.

14. The method of claim 13, wherein the combining includes:
inserting the fused small core fiber bundle and the large core diameter hollow core fiber inside a large diameter outer capillary; and
one of collapsing the large diameter outer capillary on the large core diameter hollow core fiber and fused small core fiber bundle, and attaching using a UV curable resin the large diameter outer capillary to the large core diameter hollow core fiber and the fused small core fiber bundle.

15. The method of claim 14, further comprising removing the support structure from the plurality of small core diameter hollow core fibers after the formation of the fused small core fiber bundle.

16. The method of claim 15, wherein the support structure is one of metal, ceramic or polymer ring.

17. The method of claim 15, wherein the support structure is removed by chemically or physically etching the support structure.

18. The method of claim 15, the large diameter inner capillary and the large diameter outer capillary are collapsed using a heat source.

19. The method of claim 18, wherein the heat source is one of an electric heater, a flame, a CO2 laser, and an Infra red furnace.
